(19) United States
(12) Patent Application Publication
(10) Pub. No.: US 2007/0113480 A1
(43) Pub. Date: May 24, 2007

(54) Link structure of power tailgate

(75) Inventor: Young-Gil Choi, Gyeonggi-do (KR)

Correspondence Address: EDWARDS & ANGELL, LLP, P.O. BOX 55874, BOSTON, MA, 02205, US

(73) Assignees: Kia Motors Corporation, Seoul (KR); Hyundai Motor Company, Seoul (KR)

(21) Appl. No.: 11/297,830

(22) Filed: Dec. 7, 2005

(30) Foreign Application Priority Data
Nov. 24, 2005 (KR) 10-2005-0112713

(51) Int. Cl. E05F 15/02

(52) U.S. Cl. 49/342; 49/340

(57) ABSTRACT

A link structure of a power tailgate is disclosed in which the links opening and closing the tailgate move perpendicularly in relation to the rotational direction of the driving motor, thereby preventing an overload of the motor. Accordingly, a small capacity motor may be used for reducing the weight and raw material cost thereof. Further, as the orientation of the links is in the longitudinal direction of the vehicle body, a compact link construction is provided. Such the structure includes a rack gear meshing with a driving gear of the motor, and a multi-joint link connected at both ends thereof to the rack gear and tailgate, respectively. The multi-joint link is constituted by a plurality of link members relatively and pivotally connected to each other by means of pins.

### CROSS-REFERENCE TO RELATED APPLICATIONS

The present application is based on, and claims priority from, Korean Application Serial Number 10-2005-0112713, filed on Nov. 24, 2005, the disclosure of which is hereby incorporated by reference herein in its entirety.

### Field of the Invention

The present invention relates to a power tailgate that is opened and closed by a motor through a plurality of links connected to each other by means of pins, thereby preventing the tailgate motor from being overloaded and providing a compact link structure.

### BACKGROUND OF THE INVENTION

The electric power tailgate is used in recent vehicles responding to the consumers' desire for convenience. The power tailgate is typically equipped with a driving motor located at the vehicle body, a link rod connected at one end thereof to the tailgate and formed at the other end thereof with a rack gear, and a guide channel formed at the vehicle body for guiding the movement of the link rod.

If the manipulation switch is activated, the power is provided to the, motor and the rotational shaft of the motor starts to rotate. The driving gear installed at the rotational shaft of the motor also rotates and vertically shifts the rack gear along the guide channel. While the link rod assembled to the rack gear ascends and descends along the guide channel, the tailgate is opened and closed.

However, in such the power tailgate, the link rod is slant in relation to the moving direction of the rack gear so that the motor should have a large torque capacity against the heavy load applied to the motor during the initial opening of the tailgate. This causes an increase of the weight and cost of the motor.

Furthermore, a space for the formation of the guide channel or for the movement of the link rod should be obtained; however, it is difficult in construction to have a spacious room in the limited vehicle body.

### SUMMARY OF THE INVENTION

Embodiments of the present invention are provided with links that open and close a tailgate by moving perpendicularly in relation to the rotation direction of a driving motor, thereby preventing an overload of the motor. Accordingly, a small capacity motor can be used for reducing the weight and the raw material cost of the motor. Furthermore, as the orientation of the links is in the longitudinal direction of the vehicle body at all times, the links can be installed in a compact construction.

A link structure of a power tailgate comprises a rack gear meshing with a driving gear of a motor. A multi-joint link is connected at both ends thereof to the rack gear and tailgate, respectively. The multi-joint link is composed of a plurality of link members that are relatively and pivotally connected to each other via pins.

The link member preferably includes a link body that is in the shape of a rectangular block. A pin boss protrudes at the front of the link body in an arc shape for allowing the pin to be inserted therein. A receiving groove is formed in a semi-circular shape at the rear of the link body for being inserted by the pin boss. Two flanges protrude at both rear sides of the link body for being penetrated by the pin. A vertical wall is formed at the front lower portion of the link body. An oblique wall is formed at the front upper portion of the link body at a predetermined angle.

### BRIEF DESCRIPTION OF THE DRAWINGS

For a better understanding of the nature and objects of the present invention, reference should be made to the following detailed description with the accompanying drawings, in which:

FIG. 1 is a side view illustrating a connected state of a tailgate with links according to an embodiment of the present invention; and

FIG. 2 illustrates perspective views of a link according to an embodiment of the present invention.

### DETAILED DESCRIPTION OF THE PREFERRED EMBODIMENTS

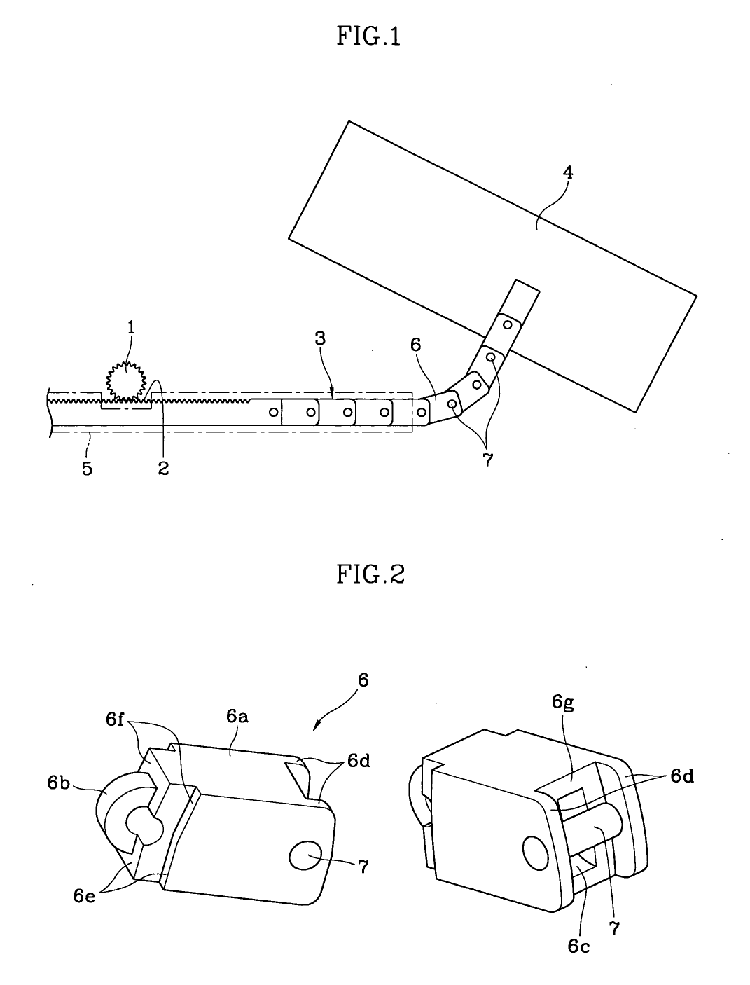

FIG. 1 is a view for describing an operation of a tailgate using a link structure according to the present invention. A rack gear 2 meshes with a driving gear 1 of a motor (not shown) for moving in the anteroposterior direction of the vehicle, in which the motor is installed at the vehicle body and provides the power to open and close the tailgate. Rack gear 2 is interactively connected to one end of a multi-joint link 3. The other end of multi-joint link 3 is fixed at a tailgate 4.

Rack gear 2 is installed in a housing 5 and moves back and forth therein. Housing 5 is fixed at the vehicle body and typically has a rectangular block shape with a hole at the upper surface thereof through which the gear teeth of driving gear 1 are inserted and mesh with rack gear placed in the housing.

As driving gear 1 rotates clockwise or counterclockwise, the rack gear moves back and forth in housing 5 accordingly.

When multi-joint link 3 connected to the rack gear moves back and forth in accordance with the rotation of the driving gear, the tailgate is opened and closed.

Multi-joint link 3 is composed of a plurality of link members 6 connected to each other via pins 7.

As illustrated in detail in FIG. 2, link member 6 includes a link body 6a having a rectangular block shape. A pin boss 6b protrudes at the front of link body 6a in an arc shape for allowing pin 7 to be inserted therein. A receiving groove 6c is formed in a semi-circular shape at the rear of link body 6a for being inserted by pin boss 6b. Two flanges 6d protrude at both rear sides of link body 6a. While pin boss 6b of one link member (hereinafter, a first link member) is fixed in receiving groove 6c of another link member (hereinafter, a second link member), if pin 7 passes through two flanges 6d of the second link member and pin boss 6b of the first link member, the first and second link members are connected to each other for relatively rotating to each other.

The front lower portion of link body 6a is formed with a vertical wall 6e while the front upper portion of link body 6a is formed with an oblique wall 6f at a predetermined angle.

Therefore, when the rear link member relatively rotates with respect to the front link member via the pin, the rotational angle thereof is restrained by oblique wall 6f. That is, the rear link member can pivot only in the counterclockwise direction until the oblique wall 6f thereof contacts a stopper wall 6g formed around receiving groove 6c of the front link member. A relative clockwise rotation of the front link member against the rear link member is prevented by the interaction of vertical wall 6e and vertical stopper wall 6g.

A maximum relative pivot angle between the link members is determined according to the inclined angle of the oblique wall. If the pivot angle is suitably adjusted, the number of link members constituting multi-joint link 3 can also be varied. The number of link members can be reduced by enlarging the pivot angle.

As the link and rack gear move perpendicularly in relation to the rotational direction of the driving gear at all times, the load applied to the driving motor during the opening and closing of the tailgate is minimized. Therefore, a motor with a relatively small torque capacity may preferably be used for reducing the weight and cost thereof.

Furthermore, the link is mounted in the longitudinal direction of the vehicle body, thus optimizing the installation space thereof. Such the compact construction enhances the degree of freedom of design.

As apparent from the foregoing, there is an advantage in that the multi-joint link supporting the tailgate to the vehicle body moves perpendicularly in relation to the rotational direction of the driving gear of the power tailgate at all times so that the load applied to the driving motor is decreased, and the weight and raw material cost of the motor may be reduced by using a small capacity motor. Also, a minimum space is required to install the links, thus enabling to embody a compact link structure.

1. A link structure of a power tailgate, comprising:
a rack gear meshing with a driving gear of a motor; and
a multi-joint link that is connected at both ends thereof to said rack gear and tailgate, respectively, and is composed of a plurality of link members relatively and pivotally connected to each other via pins.

2. The link structure as defined in claim 1, wherein said link member includes:
a link body that is in a shape of a rectangular block;
a pin boss protruding at a front of said link body in an arc shape for allowing said pin to be inserted therein;
a receiving groove formed in a semi-circular shape at a rear of said link body for being inserted by said pin boss;
two flanges protruding at both rear sides of said link body for being penetrated by said pin;
a vertical wall formed at a front lower portion of said link body; and
an oblique wall formed at a front upper portion of said link body at a predetermined angle.

3. The link structure as defined in claim 2, wherein said rack gear is installed in a housing and moves back and forth therein, and said housing is formed with a hole through which gear teeth of said driving gear are inserted and mesh with said rack gear.

4. A link structure of a power tailgate, comprising:
a rack gear meshing with a driving gear of a motor; and
a multi-joint link that is connected to the rack gear and tailgate and comprising a plurality of link members relatively and pivotally connected to each other via pins.

5. The link structure of claim 4 wherein the link member comprises:
a link body that is in a shape of a rectangular block;
a pin boss protruding from the link body and configured to allow a pin to be inserted therein;
a receiving groove configured for communicating with the pin boss;
one or more flanges protruding from the link body for being penetrated by the pin;
a vertical wall formed at a front lower portion of the link body; and
an oblique wall formed at a front upper portion of the link body at a predetermined angle.

6. A vehicle comprising a link structure of claim 1.

7. A vehicle comprising a link structure of claim 5.
